(19) United States
(12) Patent Application Publication
(10) Pub. No.: US 2015/0158252 A1
(43) Pub. Date: Jun. 11, 2015

(54) Three-dimensional Printing Catalog System and Methods of Use and Doing Business

(71) Applicant: Full Spectrum Laser LLC, Las Vegas, NV (US)

(72) Inventors: Henry J. Liu, Las Vegas, NV (US); Andrew Boggeri, Las Vegas, NV (US); Phil Joy, Las Vegas, NV (US)

(21) Appl. No.: 14/565,251

(22) Filed: Dec. 9, 2014

Related U.S. Application Data
(60) Provisional application No. 61/913,500, filed on Dec. 9, 2013.

(51) Int. Cl. B29C 67/00; G06F 17/50; G05B 15/02

(52) U.S. Cl. CPC B29C 67/0088; G05B 15/02; G06F 17/50; B33Y 50/02

(57) ABSTRACT

A three-dimensional printing catalog system and methods of use and doing business. A 3D printer provides access to one or more catalogs of printable models. The printer includes a three-dimensional print engine, a device interface in communication with the print engine, a user interface in communication with a catalog of remotely-stored model data sets, local storage, and a network communication link in communication with the user and device interfaces, the local storage, and the remotely-stored model data sets.

### CROSS-REFERENCE TO RELATED APPLICATIONS

This application claims priority from provisional patent application Ser. No. 61/913,500 filed Dec. 9, 2013 and titled “Single Action Computer Controlled Manufacturing Device Catalog and Media Interface,” the entire contents of which are incorporated herein by this reference.

### TECHNICAL FIELD

This invention is in the technical field of additive manufacturing.

Applicants' View of Aspects of Prior Art

Additive Manufacturing (AM), also known as three-dimensional (3D) printing, is a term describing a variety of manufacturing technologies whereby a three-dimensional object (a model) is created from a 3D model through selective accumulation of material. Many AM methods create models through sequential construction of thin layers (slices) that approximate boundary surfaces of the object. AM technologies include layered inkjet deposition, Fused Deposition Modelling (FDM), Stereo Lithography (SLA), Selective Laser Melting (SLM) and Selective Laser Sintering (SLS). Layered inkjet deposition involves a layer-by-layer deposit of materials in a manner analogous to that used by an inkjet printer to deposit a single layer of ink onto a sheet of paper. Other 3D printing technologies typically involve layer-by-layer consolidation of powdered materials using a laser beam, an electron beam, or some other source of concentrated energy. Applications for additive manufacturing include prototyping, tooling, architecture, medical, dental and direct part production.

A 3D printer requires a description of whatever model is to be manufactured. Such descriptions take the form of computer-generated instructions. A number of online services such as Thingiverse.com and Cubify.com provide sets of data that can be used to create manufacturing instructions capable of producing various models. These data sets are typically provided in an industry-standard format using a file designator of type *.STL.

These industry-standard data sets are of a generic format and are not intended for use with any specific 3D printer. Moreover, these instructions often contain errors including inward-facing triangles, edges sharing more or less than two triangles, edges on degenerate triangles, and incorrect winding order. To print these models without failure, a plethora of print parameters specific to the print substrate and particular 3D printer must be determined. These parameters include, by way of example, optimal model placement and positioning, structural supports, individual layer construction parameters and infill patterns, and mechanical properties and parameters.

Structural supports must be determined according to load bearing characteristic of separate sections of the model. Algorithmic support generation may be used to place support structures at specific locations. Manual support placement is often required for complex or non-solid models.

Mechanical properties and parameters include for example scan speed, tilt speed, motor acceleration and velocity, and parameters based on beam kerf in the case of scanning galvanometer-based stereo lithography 3D printers.

Obtaining a source data set and utilizing it to produce manufacturing instructions specific to a 3D printer often requires the use of a computer to create, or to obtain from an external source, the necessary instructions and parameters. The applicants have recognized that this complexity has discouraged many potential users of 3D printing technology and has prevented the use of 3D printing technology on a wider scale.

### BRIEF SUMMARY

In one aspect, the applicants have developed a remotely accessible plurality of manufacturing information (model data) that can be accessed by a 3D printer to fabricate objects (models) with the model data. In some embodiments, the remotely accessible data can be used to provide a new business, such as providing model data for a fee.

In another aspect, the 3D printer provides a catalog of printable models. This 3D printer includes a three-dimensional print engine, a device interface in communication with the print engine, a user interface, local storage, a runtime module in communication with the user and device interfaces and the local storage, and a communication link in communication with the runtime module.

In some embodiments the runtime module comprises a microprocessor. The runtime module may include a data bound list and a backing data store that may include instructions obtained locally or remotely. The user interface may include a touchscreen with either or both of graphic display and soft key capabilities.

The local storage may include a plurality of sets of instructions for manufacturing various models. In some embodiments the local storage includes machine instructions for carrying out the various functions performed locally by the 3D printer. The local storage may include a predetermined set of print engine rules that may be used to correct errors in manufacturing instructions or to modify such instructions for the particular print engine used in the 3D printer.

The user interface may facilitate browsing and retrieval of print or manufacturing data specific to additive or subtractive manufacturing. The manufacturing data is intended to enable the 3D printer to produce tangible output by way of the particular print engine used. Descriptive information and metadata pertaining to the manufacturing instructions may also be provided.

Authorization of a user, or payment for manufacturing instructions, may be facilitated by the runtime module and the user interface.

In one aspect, a 3D printer has the capability to retrieve and display a catalog of prepared sets of manufacturing instructions (printable media) for a print engine. A user can browse the catalog directly from the printer rather than first downloading a file from a remote source into an external local computer. The catalog may be contained on removable storage media, or it can be downloaded from local storage or through an external network connection. The catalog may contain images and descriptions of 3D printable models that have already been tested and printed on the particular print engine to be used. Setup parameters such as orientation, size, layer thickness and material may be predetermined or directly configurable through the user interface. In some embodiments the user need only select a picture or description of a model to be fabricated and the 3D printer thereupon fabricates the model.

There are other aspects and novel features of the present specification. They will become apparent as the specification proceeds. The scope of claimed subject matter is to be determined by the claims as issued and not the Brief Aspects section or this Brief Summary.

### BRIEF DESCRIPTION OF THE DRAWINGS

The preferred and other embodiments are disclosed in association with the accompanying exemplary figures.

FIG. 1 is a perspective view of a 3D printer that provides a catalog of printable models according to an embodiment.

FIG. 2 is a screen shot of an image that may appear on the user interface of FIG. 1 according to an embodiment.

FIG. 3 is a block diagram of a three-dimensional printer that provides access to one or more catalogs of model data sets according to an embodiment.

FIG. 4 is a flowchart of a method of fabricating objects including object selection from a catalog of remotely-located model data sets according to an embodiment.

FIG. 5 is a flowchart of a method of managing three-dimensional manufacturing in a remotely-located three-dimensional printer including object selection form a catalog according to an embodiment.

FIG. 6 is a block diagram describing at a high level an embodiment of a three-dimensional printer that provides a catalog of printable models.

FIG. 7 is a block diagram of a 3D printer that provides a catalog of printable models according to an embodiment.

FIG. 8 is a screenshot depicting tables and attributes for logical databases in a remote data store.

FIG. 9 is a screenshot depicting categories of manufacturing information

FIG. 10 is a screenshot depicting models within a category of manufacturing information.

FIG. 11 is a screenshot depicting details of a model.

FIG. 12 is a screenshot depicting information displayed to a user and selections a user may make.

FIG. 13 is a screenshot of an initial sign-in screen for use by a customer in signing in to a remote database of manufacturing information to be used by a 3D printer that provides a catalog of printable models according to an embodiment.

FIG. 14 is a screenshot following the screenshot of FIG. 13 and showing a product order screen for use by the customer to select manufacturing information from a catalog of printable models for a model to be fabricated by the customer in the 3D printer.

FIG. 15 is a screenshot following the screenshot of FIG. 14 and showing a payment screen for use by the customer in paying for the selected manufacturing information.

### DETAILED DESCRIPTION

A 3D printer according to an embodiment includes a user interface that provides access to one or more catalogs of models for which instructions are stored in the 3D printer or are obtained from a remote data store such as an online source.

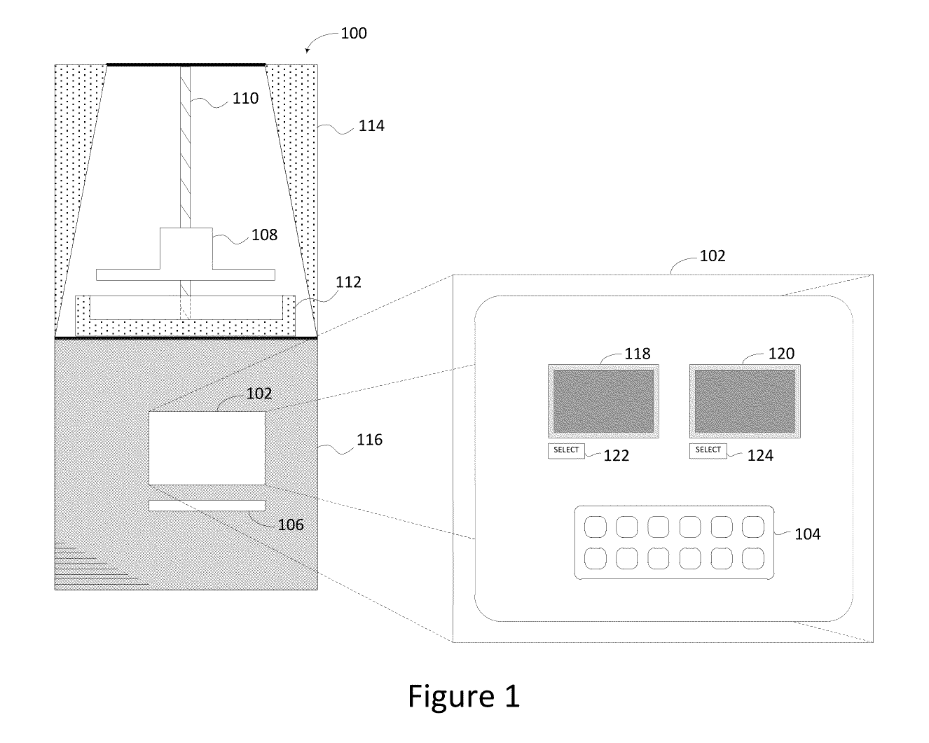

FIG. 1 depicts an embodiment of a three-dimensional printer 100 that provides a catalog of printable objects. The printer includes a user interface 102. In some embodiments the user interface 102 includes a graphics display. In some embodiments the user interface 102 provides a touch-screen that displays text or graphics (or both) to a user and receives input from a user, for example through a soft keyboard 104. In some embodiments a separate keyboard 106 receives input from a user.

In this example, the three-dimensional printer 100 is of a kind manufactured by Full Spectrum Laser of Las Vegas Nev. The printer 100 has a print head 108, a supporting shaft 110 for the print head, a tray 112 to contain resin, and a cover 114 shown partially open. The user interface 102 is mounted on a panel 116. Other printers having additional or different components may be used instead of this one.

The interface 102 is shown displaying two objects 118 and 120 from which the user can select. Below the object 118 is a soft key 122 for selecting that object 118, and below the object 120 is a soft key 124 for selecting that object 120.

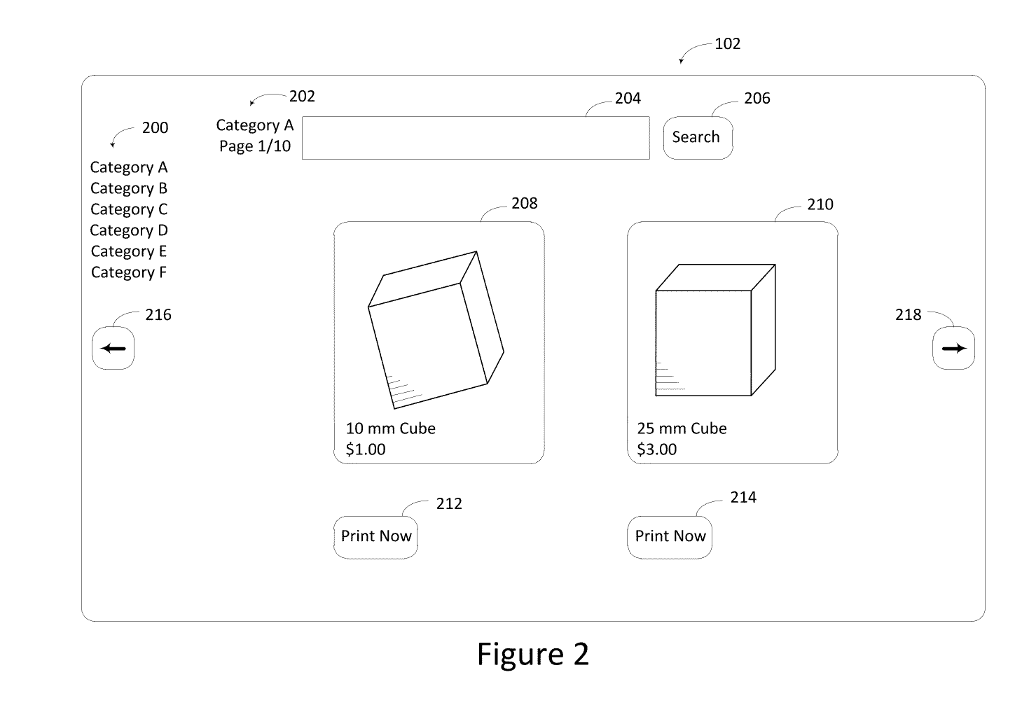

FIG. 2 provides a screen shot of a typical image that might appear on the user interface 102. In this image the user is presented with a choice 200 of categories A through F, each category including certain kinds of models. In this image the user has selected Category A as indicated by an arrow 202, which includes cubes. Other categories could be selected by entering the name of the category into a search window 204 and activating a search button 206. Two available cubes 208 and 210 are depicted. A model data set corresponding with the cube 208 is available for $1.00 and a model data set corresponding with the cube 210 is available for $3.00. The user can select the cube 208 cube by pressing a “print now” button 212 adjacent the display of the cube 208. Instead, the user can select the cube 210 cube by pressing a “print now” button 214 adjacent the display of the cube 208. The corresponding data set will thereupon be transmitted to the 3D printer where it will be converted into manufacturing instructions specific to that model of printer, and the printer will then fabricate the selected object. Scroll buttons 216 and 218 enable the user to scroll backward and forward through other screens.

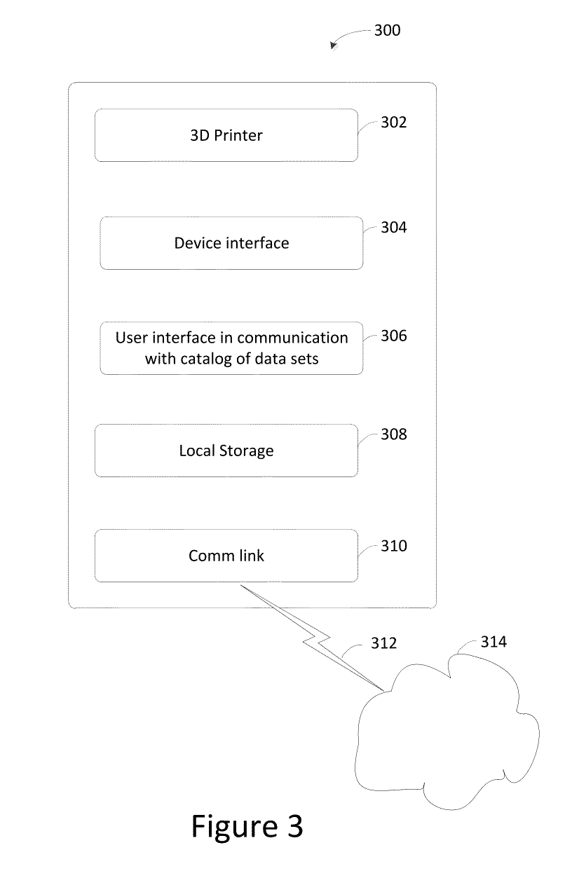

An embodiment of a three-dimensional printer generally 300 that provides access to one or more catalogs of model data sets is depicted in block diagram form in FIG. 3. This printer includes a three-dimensional print engine 302, which may be similar to or different than the 3D printer 100, a device interface 304 in communication with the print engine, a user interface 306 in communication with a catalog of remotely-stored model data sets, local storage 308, and a network communication link 310 in communication with the user and device interfaces, the local storage, and the remotely-stored model data sets as indicated by a connection 312 with a remote store represented as a cloud 314.

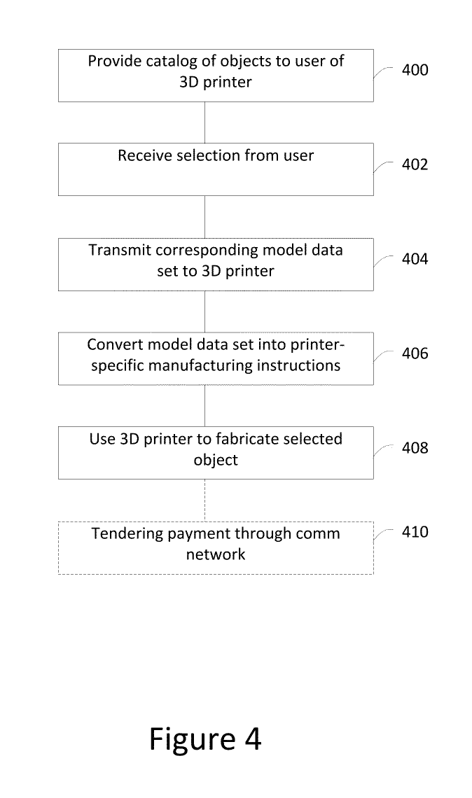

An embodiment of a method of fabricating objects is depicted in flowchart form in FIG. 4. The method includes providing (400) a catalog of objects to a user of a three-dimensional printer, receiving (402) a selection of an object from the user, transmitting (404) a remotely-stored model data set corresponding with the selected object to the three-dimensional printer, converting (406) the model data set into manufacturing instructions executable by the three-dimensional printer, and using (408) the three-dimensional printer to fabricate the object. In some embodiments providing (400) the catalog of objects comprises displaying the catalog on a user interface in the three-dimensional printer, or accessing a remotely-stored catalog. In some embodiments, some catalogs may be locally stored and others may be remotely stored and accessed as needed. In some embodiments receiving (402) a selection comprises transmitting the selection to a data store remote from the three-dimensional printer. Some embodiments also include tendering (410) payment for the selected model data set through a communication network.

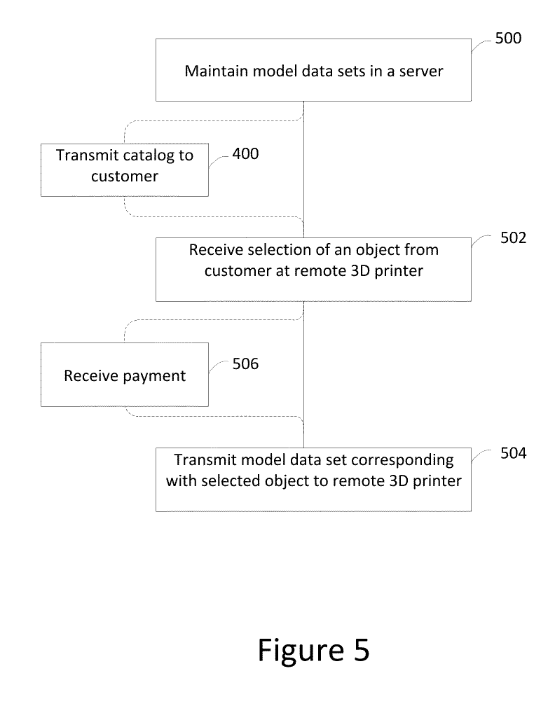

An embodiment of a method of managing three-dimensional manufacturing, which may be a method of engaging in the business of selling and distributing model data sets, is shown in flowchart form in FIG. 5. The method includes maintaining (500) in one or more servers a plurality of model data sets each corresponding with an object, receiving (502) a selection of an object by a customer at a remotely-located three-dimensional printer, and transmitting (504) a model data set corresponding with the selected object to the three-dimensional printer. Some embodiments include receiving (506) payment from the customer, before or at the same time as the transmission of the model data set (504) or at some other time as may be convenient. The customer may make the selection of an object from a catalog displayed by a user interface of the three-dimensional printer, and in some embodiments receiving (502) a selection includes transmitting (508) the catalog of objects to the user interface for display to the customer.

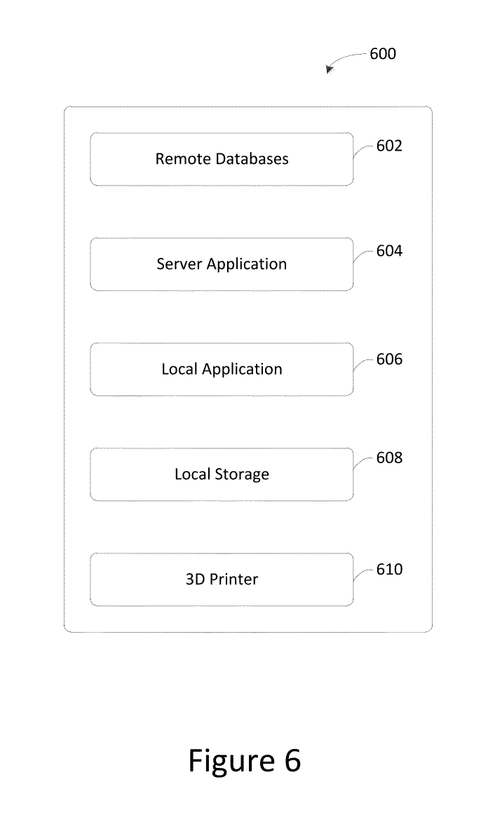

Proceeding now to describe more details of various instances, FIG. 6 is a block diagram describing at a high level an embodiment of a three-dimensional printer that provides a catalog of printable models, generally 600. This embodiment has an architecture that includes remote databases 602, a server application 604, a local application 606, local storage 608, and device hardware 610.

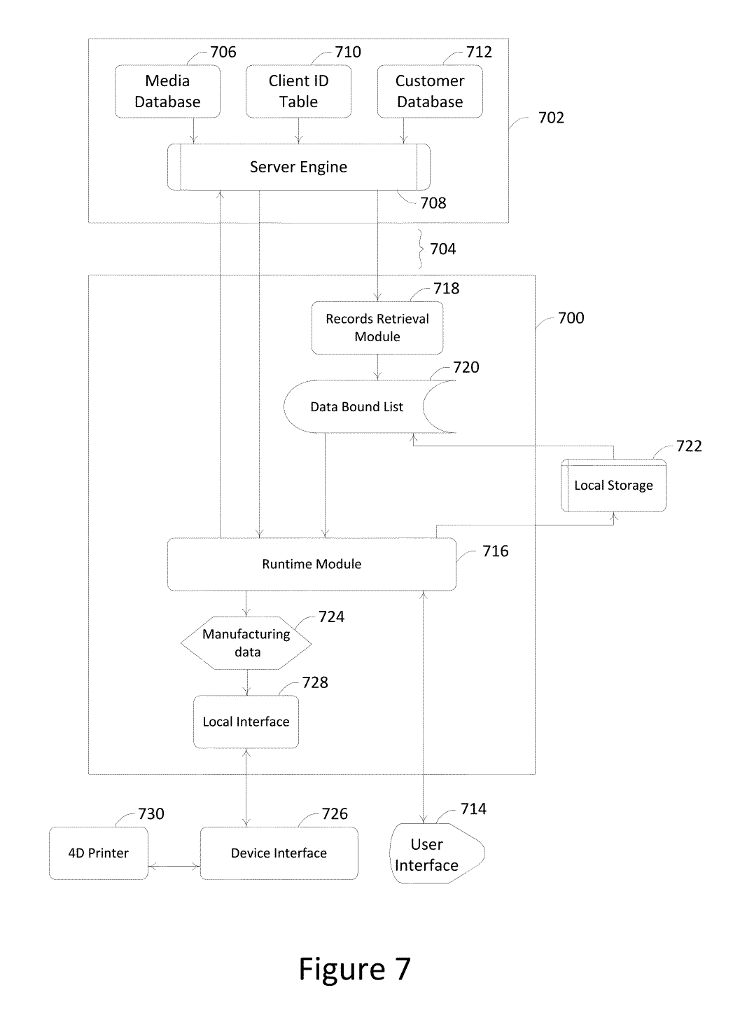

An embodiment of a three-dimensional printer that provides at least one catalog of printable models is shown in FIG. 7. This embodiment includes an application module 700 that may comprise a microprocessor (not shown). The application module 700 can obtain data from a remote data store 702, for example through a communication link 704 that may be wired or wireless. In some embodiments the communication link 704 comprises the Internet. The data store 702 may provide instructions for making various models from a media database 706. In some embodiments the media database 706 uses BLOB storage that contains compressed manufacturing data, and requests are received using HTTPS GET commands.

A client identification (ID) may be communicated by the application module 700 to a server 708 in the remote data store 702 and matched with a known client ID in a client ID table 710 to allow the application module 700 to access the instructions in the media database 706. The client ID may include details applicable to the authorization process such as personally identifying information or payment information or both. In some embodiments the client ID is organized as a MySQL or similar database that stores customer records for purposes of basic identification. The server 708 may facilitate the purchase and payment process and provide account authentication.

The client ID may be stored in a customer database 712 which may in turn provide prior activity and authorized records in relation to the session. Information may be associated with the Customer if entered through an online interface (not shown) that is separate from the 3D printer; such an online interface may embody part of a browser or a desktop application. In some embodiments the customer database 712 includes category lists together with references to manufacturing instructions contained in the media database 706. The media database 706 may also contain metadata for each project such as runtime, number of slices and text description. The manufacturing instructions may be referenced when displaying available projects in a user interface 714. Category lists may be obtained by using HTTPS GET commands.

The manufacturing instructions are transferred from the data store 702 to a runtime module 716, for example by using HTTPS GET commands. The runtime module 716 facilitates display of information on the user interface 714; receipt and processing of the manufacturing instructions; communication with the server engine 708 including for example logging and transaction processing; and queries to the media database 706, the client ID table 710, and the customer database 712.

Data respecting available manufacturing instructions and categories may be retrieved, for example by SQL queries, placed in a records retrieval module 718 and transferred from there to a data bound list 720 for display on the user interface 714. A local storage 722 may be used instead of or in addition to the data store 702 to store manufacturing instructions for making various models.

The runtime module 716 displays records through the user interface 714 according to categorization that is evident to the user such as class, group and other characteristics. These records may be displayed in a succession of page views. When instructed by a user selection, the runtime module 716 may obtain the instructions to make the selected model from the data store 702 or may retrieve the instructions from the local storage 722. The user may communicate with the 3D printer through the user interface 714, for example by means of soft keys displayed on the touch screen, or by a separate keyboard, by voice commands, or any other suitable method of communicating from a human to a machine.

In some cases, one model may be fabricated partly using instructions from the local storage 722 and partly from instructions obtained from the data store 702. In some cases, instructions may be obtained from more than one data store. If obtained from the data store 702, the server 708 may take necessary action before transferring the instructions, for example transaction logging and payment processing.

As noted above, the manufacturing instructions, if obtained from the data store 702, may be transferred into the local storage 722. Either from the data store 702 or the local storage 722 or both, the runtime module 716 transfers the instructions, represented in FIG. 7 as manufacturing instructions 724, to a device interface 726, in some embodiments through a local interface 728. The local interface 728 may comprise hardware, software, or both. The manufacturing instructions 724 may be streamed directly from the data store 702 to the device interface 726 without being stored anywhere else along the way.

The device interface 726 communicates the manufacturing instructions 724, after any modifications and corrections, to a print engine 730 which actually fabricates the model. The print engine may comprise an additive or subtractive manufacturing unit that physically makes the desired model.

The manufacturing instructions 724 may be modified for the particular print engine 730 and any errors in the instructions corrected, for example by processing the manufacturing instructions in the runtime module 716 or the device interface 726 or the local interface 728 according to a predetermined set of print engine rules that may be stored in the local storage 722 or elsewhere in the application module 700.

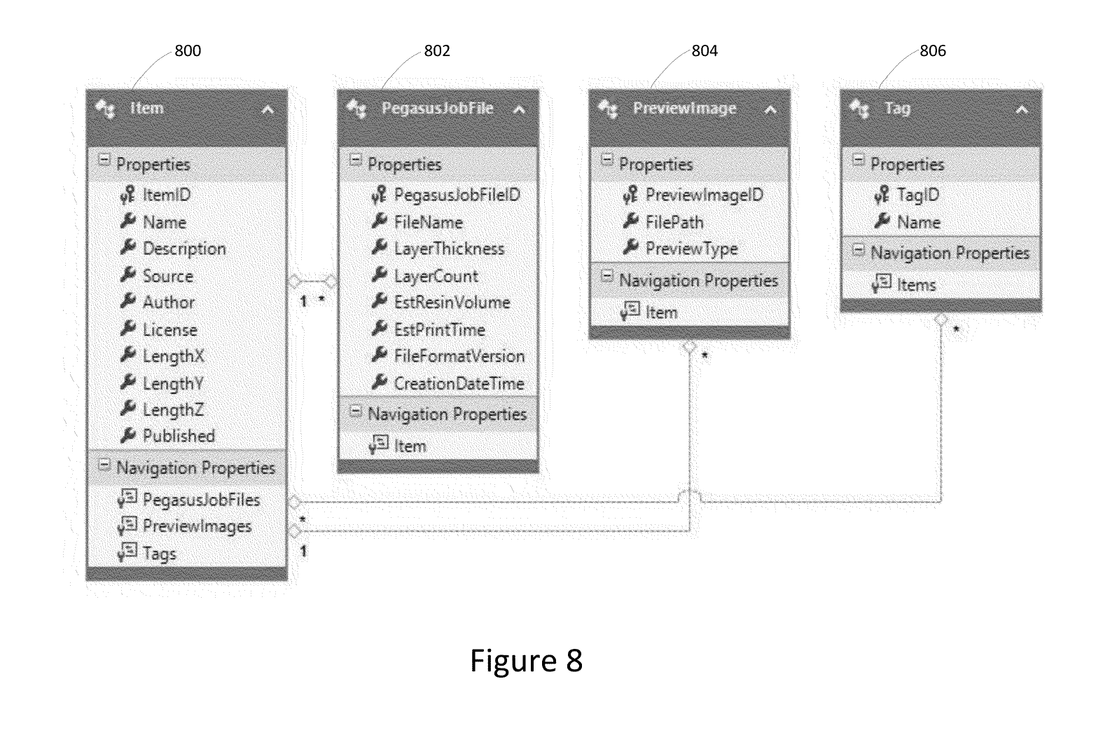

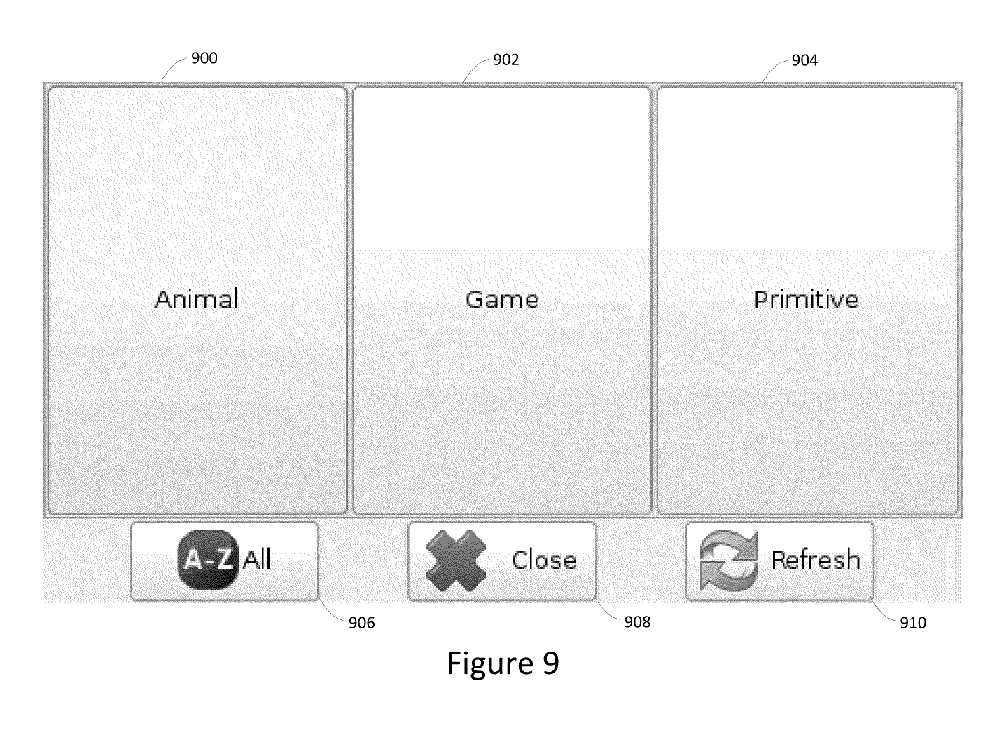

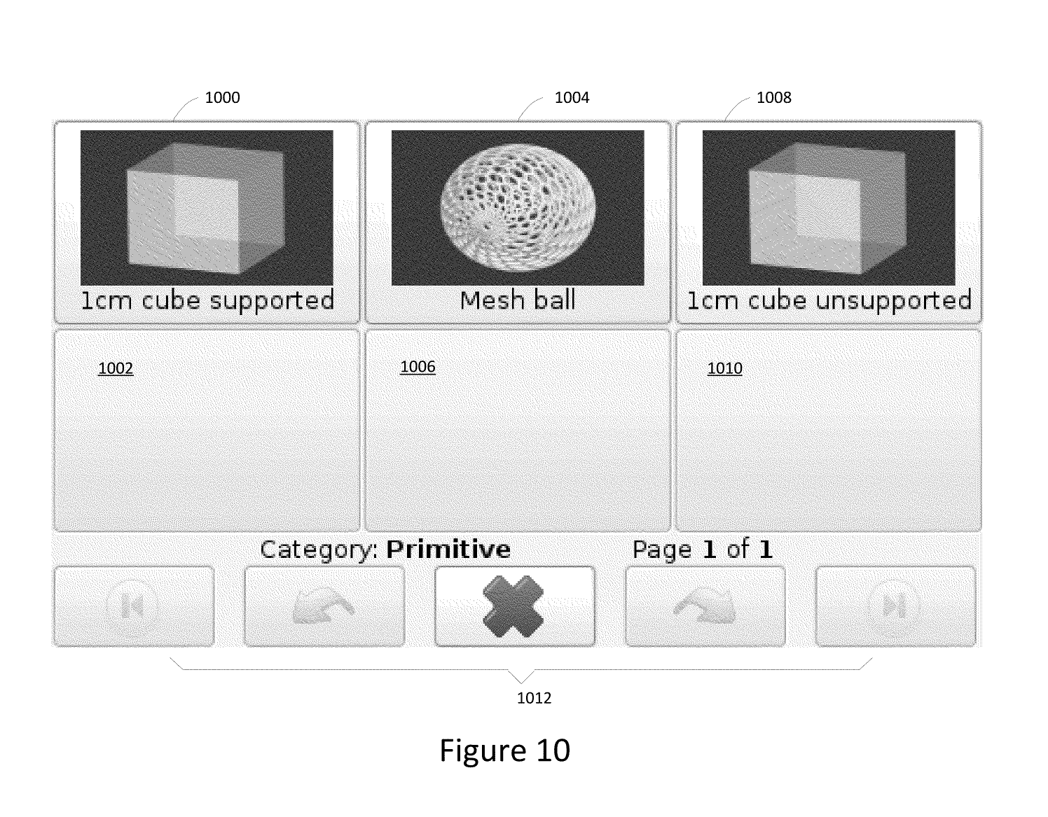

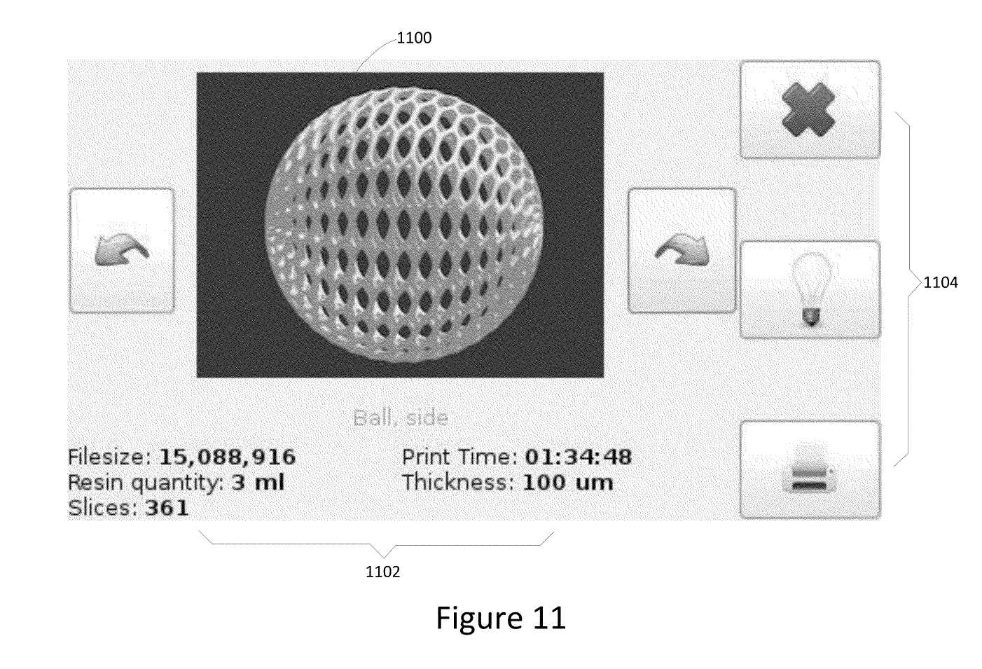

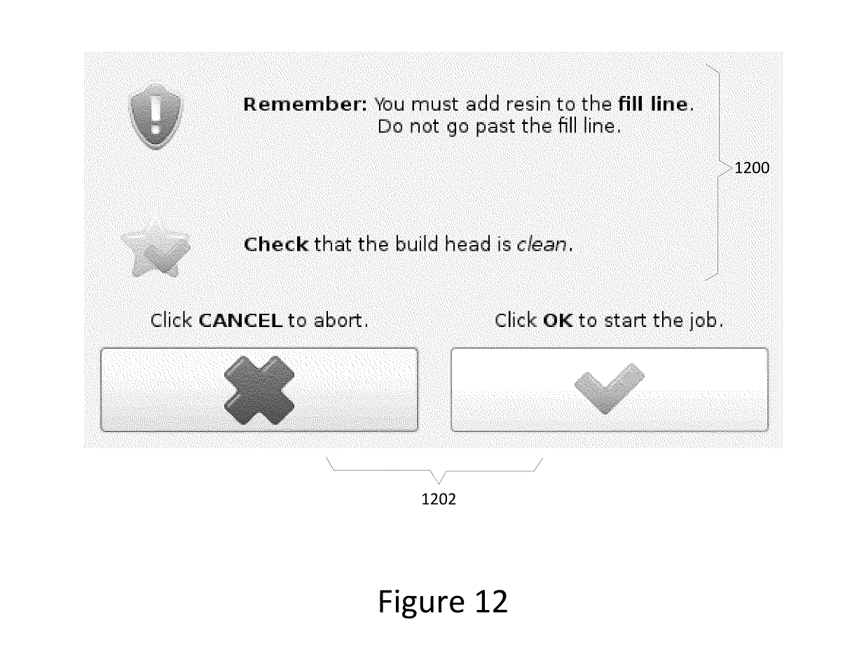

FIG. 8 is a screenshot depicting tables and attributes for logical databases in an embodiment of the remote data store 702, including an item file 800, a Pegasus job file 802, a preview image file 804, and a tag file 806. FIG. 9 is a screenshot depicting categories of manufacturing information including an “animal” category 900, a “game” category 902, and a “primitive” category 904. Also shown are buttons for user input including a button 906 for selecting categories alphabetically, a button 908 for closing the screen, and a button 910 for refreshing the screen. FIG. 10 is a screenshot depicting models within the “primitive” category 604 including an image of a supported cube 1000 and a selection button 1002 for the image 1000, an image of a mesh ball 1004 and a selection button 1006 for the image 1004, and image of an unsupported cube 1008 and a selection button 1010 for the image 1008. Buttons 1012 receive various other user commands. FIG. 11 is a screenshot depicting details of the mesh ball 1004, including a detailed image 1100 of the mesh ball, textual details 1102, and buttons 1104 for receiving various user commands. FIG. 12 is a screenshot depicting information displayed to a user including textual details 1200 and buttons 1202 for receiving various selections from a user.

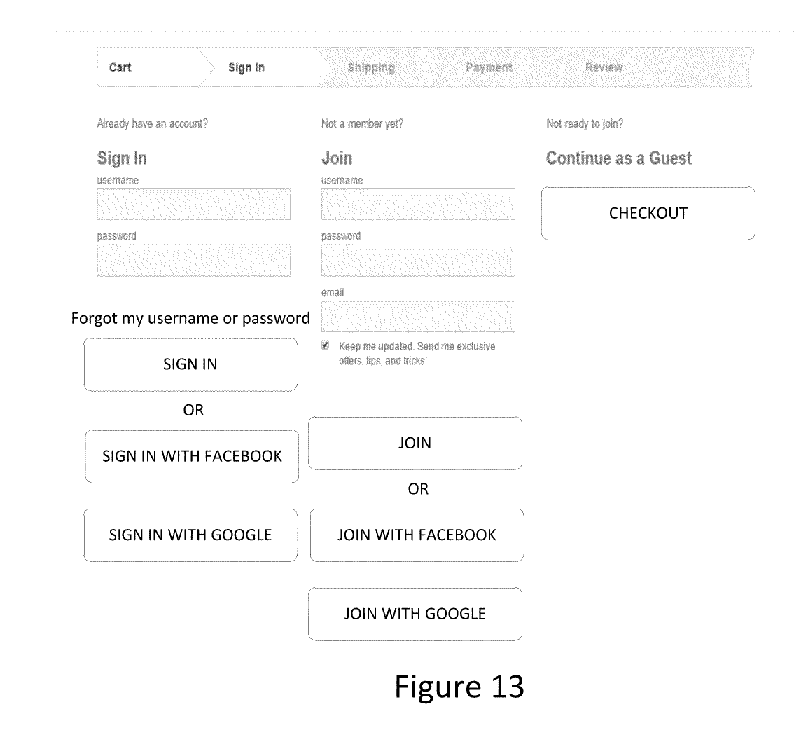

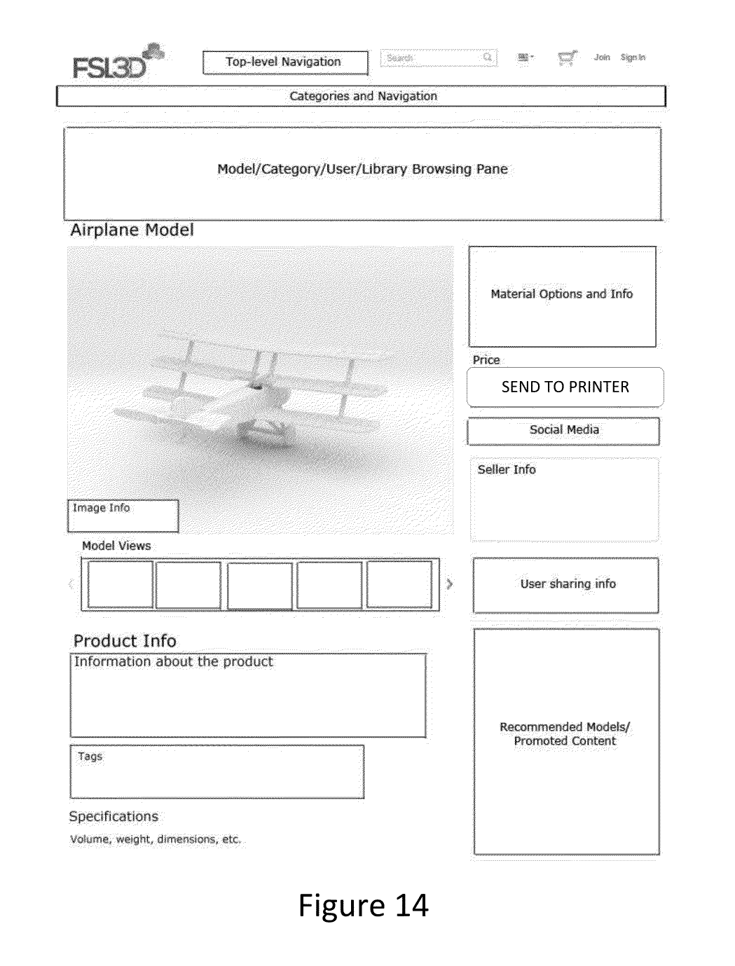

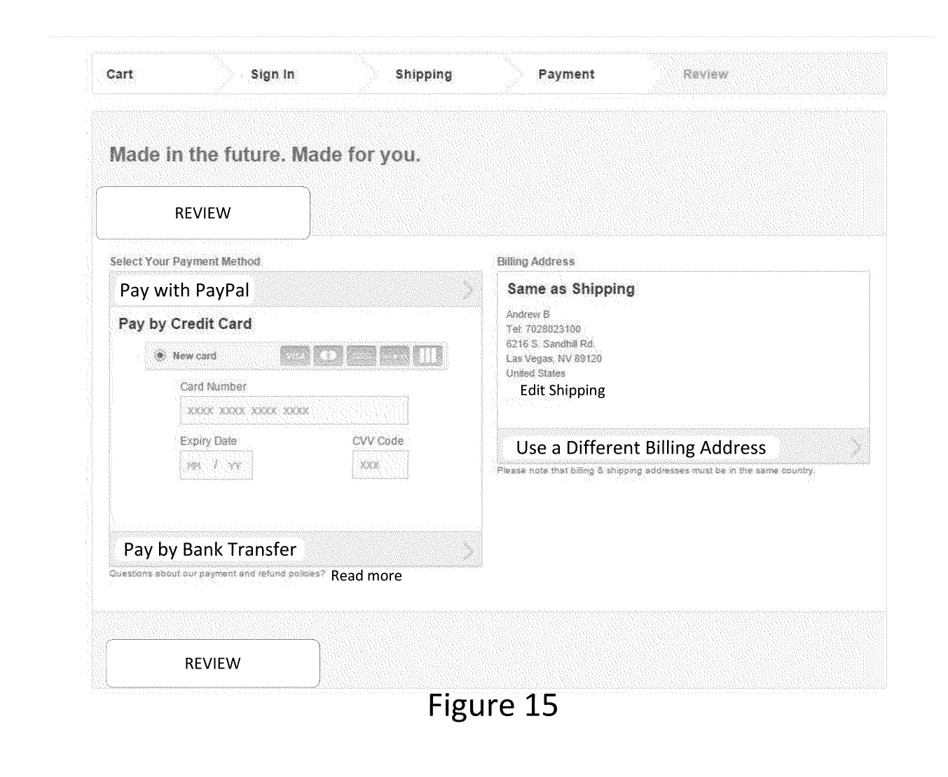

A screenshot of an initial sign-in screen is shown in FIG. 13. This sign-in screen is for use by a customer in signing in to a remote database of manufacturing information to be used by a 3D printer that provides a catalog of printable models. FIG. 14 follows the screenshot of FIG. 13, showing a product order screen for use by the customer to select manufacturing information from the catalog of printable models. FIG. 15 shows a payment screen for use by the customer in paying for the selected manufacturing information.

In some embodiments, a predetermined storage format is used for manufacturing information files and other data stored locally. A file may contain a header including manufacturing parameters of the print engine, an image lookup table, embedded images which may be in 32-bit color low-resolution lossy format, an SLA manufacturing information lookup table, and embedded manufacturing information. The manufacturing information may provide data for each slice. The slices may contain a nested data structure of geometric features and any contained geometries in which geometrics paths are represented by polylines(vector<float>). Slice data may be serialized and compressed, in some instances by more than 50%.

Manufacturing files are transferred to device local storage before print. A history of these files and associated data such as record of print times and completion status may be maintained. If available data storage space goes below a predefined limit, data may be cleared in reverse order of creation-date and time.

In some embodiments various commands issued when display controls are selected by the user may include:

```
Web Categories Screen
  // Select and display category and associated media
  private void ChooseCategory(object sender, EventArgs e, int index)
  // Pull the list of all tags from SQL database.
  public List<string> GetListOfAllCategories()
  // Exit Category screen, return to main interface
  private void CancelButton_Clicked(object sender, EventArgs e)
Web Preview Screen
  // Print job displayed in Preview Screen
  private void Print_Clicked(object sender, EventArgs e)
  // Show previous preview image associated with media
  private void Prev_Clicked(object sender, EventArgs e)
  // Show next preview image associated with media
  private void Next_Clicked(object sender, EventArgs e)
  // Show text info associated with media
  private void Info_Clicked(object sender, EventArgs e)
  // Exit Web Preview Screen, return to Web Loader Screen
  private void Cancel_Clicked(object sender, EventArgs e)
Web Loader Screen
  // Show Web Preview Screen
  private void OnFileButtonClicked(object sender, EventArgs e)
  // Exit Web Loader Screen, return to Web Categories Screen
  private void CloseButton_Clicked(object sender, EventArgs e)
  // Navigate to previous page of media objects within selected category
  void RotateLoadedFilesBackward(object sender, EventArgs e)
  // Navigate to first page of media objects within selected category
  void RotateLoadedFilesBackwardMulti(object sender, EventArgs e)
  // Navigate to next page of media objects within selected category
  void RotateLoadedFilesForward(object sender, EventArgs e)
  // Navigate to last page of media objects within selected category
  void RotateLoadedFilesForwardMulti(object sender, EventArgs e)
```

Remote BLOB storage may be used to store manufacturing data. This service may be optimized for storing large, unstructured data at minimal cost. The BLOB storage server holds unstructured data in containers with each file identified by a unique identifier. A single container is used to house all manufacturing data. Manufacturing BLOBs are retrieved from remote storage using, for example, a storage BLOB library available from Microsoft Corporation. A GET request may be made over encrypted HTTP. Data contained in the remote file is pre-compressed as specified in the file format. The data is stored and transferred without modification and is only processed immediately preceding and during the manufacturing process.

The transformation that occurs on the local device takes the reduced data representation stored on the server and transforms it into a representation that can be used to fabricate the model. This transformation may include:
storing a location of a manufacturing data file stream;
loading and storing parameters from an embedded header;
enumerating over slice collection and load nested data structures (slices) in the order they are output to hardware; and
adding processed data structure to a queue used to send the data to the hardware.

Enumerating the over slice collection and loading the nested data structures may include:
storing addresses of the nested data structure in the file stream;
loading individual slice settings if available (these override any global file or device settings if applicable), including tilt type, pre-tilt delay, post-tilt delay, and additional repetitions for the entire data structure;
loading connected line segments from the data structure and categorizing them by feature type (infill, offset, contour); and
encoding each feature and storing vector values that represent original geometry. These vectors are output to galvanometer controllers for a polymerization process.

Various categories and lists are ascertained for display on the panel, for example by means of a category table in an Azure SQL database. An HTTPS GET request is made to the server to retrieve a category list as a JSON encoded string. For example:

```
/// Pull the list of all tags from SQL database.
  public List<string> GetListOfAllCategories()
  {
    List<string> results = DownloadSerializedJsonData<List<string>>(url);
    return results;
  }
```

The server code responsible for a response is:

```
if (isset($_REQUEST[′Tags′]))
  {
    //Request was: index.php?Tags
    $json_response = Array_GetTagsFromSQL($pdo);
  }
```

The Category UI is then updated upon category list update:
private void OnCategoriesChanged(List<string> newCategories)

In some embodiments, messages between the server and local device may be formatted as JSON encoded strings. Device applications containing user interface and processes to drive the print engine may include Customized Linux Distribution, Mono Runtime, and GTK UI Toolkit. Programming languages may include C#, C++, and Assembly. Web services used as application gateways to databases may include services written in or utilizing SQL, PHP, and HTTP. As noted above, off-the-shelf libraries that may be used include Azure platform, Azure SQL, Azure Cloud Service, Microsoft Azure BLOB API, Mono Framework, and GTK UI Toolkit.

In some embodiments, finished models may be fabricated efficiently and with good surface quality and structural integrity by means of defined ranges of parameters. These parameters are defined according to the specific manufacturing data and specific resin formulations used by the print engine. A model fabricated according to these parameters has no noticeable failure of any individual feature, visual properties such as surface finish that are smooth and coincide with the graphical representation of the source data within the visualization software preceding the manufacturing process, physical properties such as Shore Hardness and elasticity that are within an expected range with respect to the structure of the source data, and tactile properties such as degree of tackiness that are within an expected range following initial cure and preceding any post cure stage. The Media Interface facilitates the display and retrieval of verified manufacturing data, providing a streamlined method of producing selected parts reliably.

A method of offering model data sets to remote customers may include providing free prints, pay-per-print, time limited prints, and promotional prints. Model data sets may comprise tested models. Model data sets may be computer-generated or produced by individuals. The individuals may include employees of a business that offers the model data sets. The individuals may include independent contract artists who may assign some or all rights in their work to the business. In some embodiments the contract artists may receive royalties. Customers, who may may be individuals or businesses, may upload model data sets. Prices may be set based on the customer's status as a hobbyist, a research laboratory, a manufacturer, or the like. The business may offer its customers access to other catalogs of model data sets in exchange for a percentage of the sale price. Limitations may be imposed on the customer as to permitted uses and redistribution of the model data sets. Limitations may include, for example, permission to make prints of a specific model on a single printer only, or permission to use the model only in a certain larger product configuration, in some instances with an assurance that no other customer will be granted identical rights.

One way revenue can be generated is by providing print tokens for purchase, where each successful print debits one or more tokens from the account. A themed set or group of models may be defined so as to enable the customer to make a certain number of prints within the group for a set price.

The various illustrative logical blocks, modules, and algorithm steps described in connection with the embodiments disclosed herein can be implemented as electronic hardware, computer software, or combinations of both. To clearly illustrate this interchangeability of hardware and software, various illustrative components, blocks, modules, and steps have been described generally in terms of their functionality. Whether such functionality is implemented as hardware or software depends upon the particular application and design constraints imposed on the overall system. The described functionality can be implemented in varying ways for each particular application, but such implementation decisions should not be interpreted as causing a departure from the scope of the disclosure.

Blocks of the methods and algorithms described in connection with the embodiments disclosed herein can be embodied directly in hardware, in a software module executed by a processor, or in a combination of the two. A software module can reside in any suitable form of electronic storage medium. Such a storage medium is coupled to a processor such that the processor can read information from, and write information to, the storage medium. In some embodiments a storage medium can be integral with a processor, either or both of which may be implemented in an ASIC.

Depending on the embodiment, certain acts, events, or functions of any of the methods described herein can be performed in a different sequence, can be added, merged, or left out altogether (e.g., not all described acts or events are necessary for the practice of the method). Acts or events can be performed concurrently, for example through multi-threaded processing, interrupt processing, or multiple processors or processor cores, rather than sequentially. Acts or events can be performed on alternate tiers.

Unless otherwise noted, the terms “a” or “an” as used in the specification and claims are to be construed as meaning “at least one;” the word “or” is used in the inclusive-or sense such that “A or B” means A or B or both A and B; and the words “including” and “having” are interchangeable with and have the same meaning as the word “comprising.”

While the foregoing detailed description enables one of ordinary skill to make and use what is considered presently to be the best mode, there are variations, combinations, and equivalents of the specific embodiments, methods, and examples described herein. The invention is not to be limited by the foregoing embodiments, methods, and examples, but by all embodiments and methods within the scope of the claims.

1. A three-dimensional printer that provides access to one or more catalogs of model data sets, comprising:
a three-dimensional print engine;
a device interface in communication with the print engine;
a user interface in communication with a catalog of remotely-stored model data sets;
local storage; and
a network communication link in communication with the user and device interfaces, the local storage, and the remotely-stored model data sets.

2. The printer of claim 1 and further comprising a runtime module.

3. The printer of claim 2 wherein the runtime module comprises a microprocessor.

4. The printer of claim 1 wherein the user interface comprises a touchscreen.

5. The printer of claim 1 and further comprising a predetermined set of print engine rules.

6. The printer of claim 1 wherein the remotely-stored model data sets comprise data accessible by way of the Internet.

7. The printer of claim 1 wherein the remotely-stored model data sets comprise data stored in a cloud storage environment.

8. A three-dimensional printing catalog system that fabricates objects according to catalogs of remotely-located model data sets, the system comprising:
a three-dimensional print engine;
a device interface in communication with the print engine;
local storage;
a network communication link in communication with the runtime module; and
a user interface in communication with a catalog of objects and with remotely-stored model data sets corresponding with the objects through the network communication link.

9. The system of claim 8 wherein the catalog comprises remotely-stored information.

10. The system of claim 8 wherein the network communication link comprises the Internet.

11. The system of claim 8 wherein the remotely-stored data sets comprise data stored in a cloud storage environment.

12. The system of claim 11 wherein the catalog comprises information stored in the cloud storage environment.

13. The system of claim 11 and further comprising a predetermined set of print engine rules in the local storage.

14. A method of fabricating objects, the method comprising:
providing a catalog of objects to a user of a three-dimensional printer;
receiving a selection of an object from the user;
transmitting a remotely-stored model data set corresponding with the selected object to the three-dimensional printer;
converting the model data set into manufacturing instructions executable by the three-dimensional printer; and
using the three-dimensional printer to fabricate the object.

15. The method of claim 14 wherein providing a catalog of objects comprises displaying the catalog on a user interface in the three-dimensional printer.

16. The method of claim 14 wherein providing a catalog of objects comprises accessing a remotely-stored catalog.

17. The method of claim 14 wherein receiving a selection comprises transmitting the selection to a data store remote from the three-dimensional printer.

18. The method of claim 14 and further comprising tendering payment for the selected model data set through a communication network.

19. A method of managing three-dimensional manufacturing, the method comprising:
maintaining in one or more servers a plurality of model data sets each corresponding with an object;
receiving a selection of an object by a customer at a remotely-located three-dimensional printer; and
transmitting a model data set corresponding with the selected object to the three-dimensional printer.

20. The method of claim 19 and further comprising receiving payment from the customer.

21. The method of claim 19 wherein the customer makes the selection from a catalog displayed by a user interface of the three-dimensional printer.

22. The method of claim 20 wherein receiving a selection comprises transmitting a catalog of objects to the user interface for display to the customer.
